(19) United States
(12) Patent Application Publication
(10) Pub. No.: US 2014/0081832 A1
(43) Pub. Date: Mar. 20, 2014

(54) SYSTEM AND METHOD FOR BUILDING AND VALIDATING A CREDIT SCORING FUNCTION

(71) Applicants: Douglas Merrill, Los Angeles, CA (US); John Merrill, Redmond, WA (US); Shawn M. Budde, Evanston, IL (US); Lingyun Gu, Thousand Oaks, CA (US); James P. McGuire, Long Beach, CA (US); Manoj Pinnamaneni, Los Angeles, CA (US)

(72) Inventors: Douglas Merrill, Los Angeles, CA (US); John Merrill, Redmond, WA (US); Shawn M. Budde, Evanston, IL (US); Lingyun Gu, Thousand Oaks, CA (US); James P. McGuire, Long Beach, CA (US); Manoj Pinnamaneni, Los Angeles, CA (US)

(21) Appl. No.: 13/622,260

(22) Filed: Sep. 18, 2012

(51) Int. Cl. G06Q 40/02

(52) U.S. Cl. CPC G06Q 40/025
USPC 705/38

(57) ABSTRACT

This invention relates generally to the personal finance and banking field, and more particularly to the field of credit scoring methods and systems. Preferred embodiments of the present invention provide systems and methods for building and validating a credit scoring function based on a creditor's target information from non-traditional sources using specific algorithms.

### CROSS-REFERENCE TO RELATED APPLICATIONS

This application is a continuation-in-part application of U.S. application Ser. No. 13/454,970, entitled “SYSTEM AND METHOD FOR PROVIDING CREDIT TO UNDERSERVED BORROWERS” filed Apr. 24, 2012, which claims priority to U.S. Provisional Application, No. 61/545,496, entitled “Using Machine Learning to Guide Human Questioning in Underbanked Underwriting” filed Oct. 10, 2011, which are all hereby incorporated in their entirety by reference.

### TECHNICAL FIELD

This invention relates generally to the personal finance and banking field, and more particularly to the field of credit scoring methods and systems.

### BACKGROUND AND SUMMARY

People use credit daily for purchases large and small. In the 1950's, credit decisions were made by bank credit officials; these officials knew the applicant, since they usually lived in the same town, and would make credit decisions based on this knowledge. This was effective, but extremely limited, since there are relatively fewer credit officials than potential borrowers. In the 1970's, the FICO score made credit far more available, effectively removing the credit officer from the process. However, the risk management function still needs to be done. Lenders, such as banks and credit card companies, use credit scores to evaluate the potential risk posed by lending money to consumers. In order to determine who is entitled to credit, and who is not, banks use credit scoring functions that purport to measure the creditworthiness of a person or entity (i.e. the likelihood that person will pay his or her debts). Traditional credit scoring functions are based on human-built transformations comprised of a small number of variables.

Traditional functions calculate a creditworthiness score using a three step process. First, they look at sample data for each variable (such as salary, credit use, payment history, etc.). Second, the system will bin the values of each variable by assigning a numerical score (such as 0 to 10 for payment frequency; 0=no payment history; 1=does not pay frequently; and 10=perfect payment track record). Finally, after all the variables are transformed, the system will use either a fixed formula, or a compilation of formulas, or a machine learning algorithm to construct a formula to produce a composite score.

Traditional credit scoring transformations were largely developed in the 1950s and 1960s, when computing power and access to information was very difficult to acquire. Consequently traditional transformations are of the simplest form possible, and are limited to (a) single numeric variables for which fill-in values are easy to compute; (b) straightforward numeric interpretations of non-numeric variables; and/or (c) string variables with very few values. For example, traditional transformations work for salaries (which are numbers), dates and times (when converted into a Julian date or equivalent), addresses (when considered as latitude-longitude pairs), or even to payment frequencies, when constrained to recognizable patterns (monthly, semi-monthly, weekly, bi-weekly, etc). These transformations may even allow intermediary computations based on easily discovered relationships between fields, such as the interval between two dates or the distance between two locations.

However, traditional credit scoring transformations do not work well for groups of variables, especially when data is partially or completely missing. And it doesn't work at all for data elements which can't be transformed. For example, an address record for Folsom State Prison may be represented as “P.O. Box 910, Represa, Calif. 95673” or “300 Prison Road, Represa, Calif. 95671”, but both refer to the same entity. Assuming a borrower's credit profile listed both addresses, a traditional credit scoring function might count the borrower as having multiple jobs, and in turn, discount his/her credit score by incorrectly presuming that the borrower's employment is less stable (i.e. affecting a calculation for a predicted paycheck).

In addition, traditional credit scoring transformations are generally limited to correcting string variables (such as addresses) for misspellings or non-standard capitalization. Advanced transformations are usually made by humans. Machine learning algorithms are generally not employed, because of their limitations in cultural knowledge and understanding. For example, a human operator would analyze the borrower's employment addresses at “P.O. Box 910, Represa, Calif. 95673” and “Post Office Box 910, Represa, Calif. 95671” and be unable to understand that both are the same location. This is normally managed by asking services to standardize addresses into USPS standard form. However, significant information is lost by standardizing addresses, such as whether the applicant used upper case and lower case, or just lower case.

As a consequence of the need for human quality control, traditional transformations are also limited in the amount of data which can be reasonably processed. Each transformation and filling-in operation may require a human to invest a significant amount of time to analyze one or more data fields, and then carefully manipulate the contents of the field. Such restraints limit the number of fields to an amount which can be understood by a single person in a reasonable period of time, and, as a result, there are relatively few risk models (such as a FICO score by Fair Isaac Corporation, Experian bureau scores, Pinnacle by Equifax, or Precision by TransUnion) with more than a few tens of variables (e.g. a FICO score is based on five basic metrics, including payment history, credit utilization, length of credit history, types of credit used, and recent searches for credit). None of the traditional credit scoring transformations consider hundreds of inputs variables, much less thousands, tens of thousands, or millions. Adding all this data enables the automated models to mimic the old-world credit officers while still retaining—and increasing—credit availability.

Accordingly, improved systems for building and validating credit scores would be desirable.

### SUMMARY OF THE INVENTION

To improve upon existing systems, preferred embodiments of the present invention provide a system and method for building and validating a credit scoring function based on a creditor's target. One preferred method for building and validating such a credit scoring function can include generating a borrower dataset at a first computer in response to receipt of a borrower profile (Raw Data); formatting the borrower dataset into a plurality of variables (Transformed Data); independently processing each of the plurality of variables using one or more algorithms (statistical, financial, machine learning, etc.) to generate a plurality of independent decision sets describing specific aspects of a borrower (Meta-Variables). As described below, the preferred method can further include feeding the Meta-Variables into statistical, financial, and other algorithms each with a different predictive “skill” (Models). Each of the Models may then “vote” their individual confidence, which then may be ensembled into a final score (Score). Other variations, features, and aspects of the system and method of the preferred embodiment are described in detail below with reference to the appended drawings.

The preferred embodiments of the present invention may also be used to provide a creditworthiness score for individuals who do not qualify under traditional credit scoring. Because certain borrowers either have an incomplete or non-existent record (based on the lack of data using traditional variables), traditional credit scoring transformations ultimately result in “un-creditworthy” scores. Thus, there are millions of individuals who do not have access to traditional credit—the so-called “underbanked”—who must survive day-to-day without such support from the financial and banking industries. By utilizing the extremely broad scope of data available from public, proprietary, and social networking data sources, as well as from the borrower himself, the present invention allows a lender to utilize new sources of information to compile risk profiles in ways traditional models could not accomplish, and in turn serve a completely new market. The present invention could be used independently (by simply generating individualized credit scores) or in the alternative, the present invention could also be interfaced with, and used in conjunction with, a system and method for providing credit to underserved borrowers. An example of such systems and methods is described in U.S. patent application Ser. No. 13/454,970, entitled “System and Method for Providing Credit to Underserved Borrowers, to Douglas Merrill et al, which is hereby incorporated by reference in its entirety (“Merrill application”).

Other systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE FIGURES

In order to better appreciate how the above-recited and other advantages and objects of the inventions are obtained, a more particular description of the embodiments briefly described above will be rendered by reference to specific embodiments thereof, which are illustrated in the accompanying drawings. It should be noted that the components in the figures are not necessarily to scale, emphasis instead being placed upon illustrating the principles of the invention. Moreover, in the figures, like reference numerals designate corresponding parts throughout the different views. However, like parts do not always have like reference numerals. Moreover, all illustrations are intended to convey concepts, where relative sizes, shapes and other detailed attributes may be illustrated schematically rather than literally or precisely.

FIG. 1 is a schematic block diagram of a system for providing credit to underserved borrowers as found in the Merrill application.

FIG. 2 is a diagram of a system for building and validating a credit scoring function in accordance with a preferred embodiment of the present invention.

FIG. 3 depicts an overall flowchart illustrating an exemplary embodiment of a method by which raw data is processed to build and validate a credit scoring function.

FIG. 4 depicts an overall flowchart illustrating an exemplary embodiment of a preferred method for building and validating a credit scoring function.

FIG. 5 depicts a flowchart illustrating an exemplary embodiment of a method for recognizing significant transformations.

FIG. 6 depicts a flowchart illustrating an exemplary embodiment of a method for building and validating scoring functions based on the selected target.

FIG. 7 is an example the computerized screen of the personal information that may be requested by a lender from a borrower as found on the preferred embodiment of present invention.

### DEFINITIONS

The following definitions are not intended to alter the plain and ordinary meaning of the terms below but are instead intended to aid the reader in explaining the inventive concepts below:

As used herein, the term “BORROWER DEVICE” shall generally refer to a desktop computer, laptop computer, notebook computer, tablet computer, mobile device such as a smart phone or personal digital assistant, smart TV, gaming console, streaming video player, or any other, suitable networking device having a web browser or stand-alone application configured to interface with and/or distribute the borrower profile to the CENTRAL COMPUTER, USER DEVICE, and/or one or more components of the preferred system 10.

As used herein, the term “USER DEVICE” shall generally refer to a desktop computer, laptop computer, notebook computer, tablet computer, mobile device such as a smart phone or personal digital assistant, smart TV, gaming console, streaming video player, or any other, suitable networking device having a web browser or stand-alone application configured to interface with and/or receive any or all data to/from the CENTRAL COMPUTER, BORROWER DEVICE, and/or one or more components of the preferred system 10.

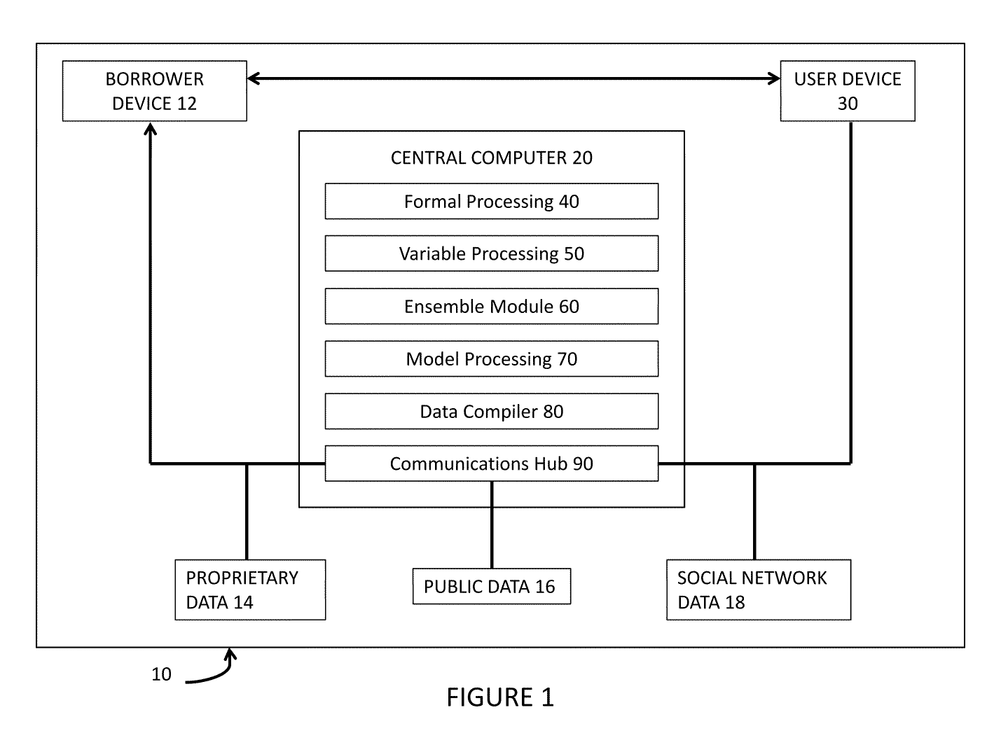

As used herein, the term “CENTRAL COMPUTER” shall generally refer to one or more sub-components or machines configured for receiving, manipulating, configuring, analyzing, synthesizing, communicating, and/or processing data associated with the borrower, (including for example: a formal processing unit 40, a variable processing unit 50, an ensemble module 60, a model processing unit 70, a data compiler 80, and a communications hub 90—See Merrill application). Any of the foregoing subcomponents or machines can optionally be integrated into a single operating unit, or distributed throughout multiple hardware entities through networked or cloud-based resources. Moreover, the central computer may be configured to interface with and/or receive any or all data to/from the USER DEVICE, BORROWER DEVICE, and/or one or more components of the preferred system 10 as shown in FIG. 1 which is described in more detail in the Merrill application, incorporated by reference in its entirety.

As used herein, the term “PROPRIETARY DATA” shall generally refer to data acquired by payment of a fee through privately or governmentally owned data stores (including without limitation, through feeds, databases, or files containing data). One example of proprietary data may include data produced by a credit rating agency during a so-called credit check. Another example is aggregations of publicly-available data over time or from multiple sources.

As used herein, the term “PUBLIC DATA” shall generally refer to data available for free or at a nominal cost through one or more search strings, automated crawls, or scrapes using any suitable searching, crawling, or scraping process, program, or protocol. One example of public data may include data produced by an internet search of a borrower's name.

As used herein, the term “SOCIAL NETWORK DATA” shall generally refer to any data related to a borrower profile and/or any blogs, posts, tweets, links, friends, likes, connections, followers, followings, pins (collectively a borrower's social graph) on a social network. Additionally, the social network data can include any social graph information for any or all members of the borrower's social network, thereby encompassing one or more degrees of separation between the borrower profile and the data extracted from the social network data. The social network data may be available for free or at a nominal cost through direct or indirect access to one or more social networking and/or blogging websites, including for example Google+, Facebook, Twitter, LinkedIn, Pinterest, tumblr, blogspot, Wordpress, and Myspace.

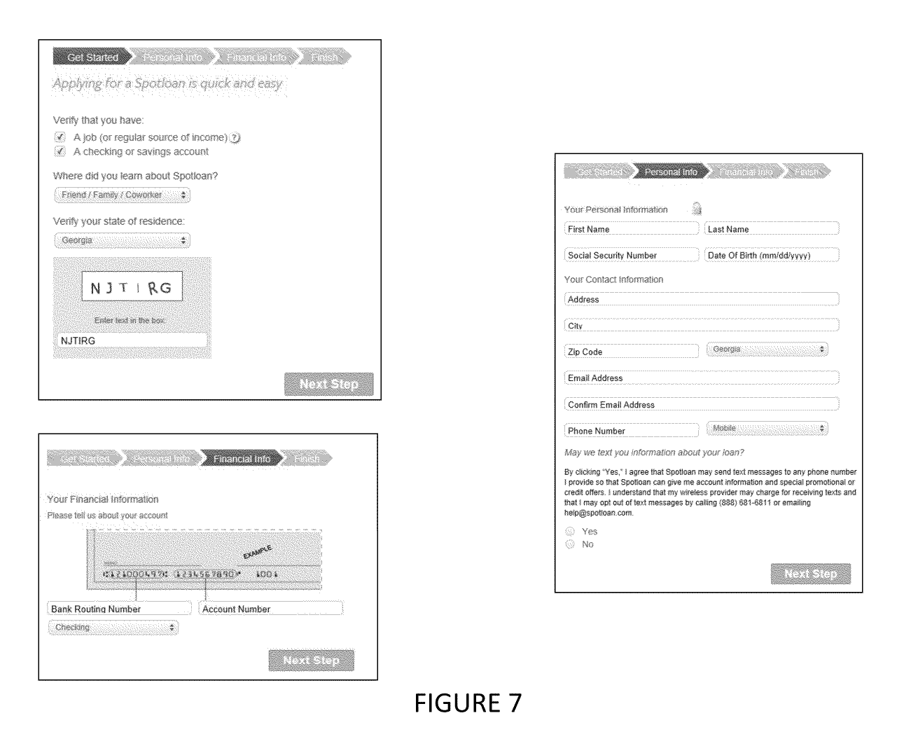

As used herein, the term “BORROWER'S DATA” shall generally refer to the borrower's data in his or her application for lending as entered into by the borrower, or on the borrower's behalf, in the BORROWER DEVICE, USER DEVICE, or CENTRAL COMPUTER. By way of example, this data may include the borrower's social security number, driver's license number, date of birth, or other information requested by a lender. An example of a lender's computer application may be seen in FIG. 7.

As used herein, the term “RAW DATASETS” shall generally refer to BORROWER'S DATA, PROPRIETARY DATA, PUBLIC DATA, and SOCIAL NETWORK DATA, individually, collectively, or in one or more combinations. Raw datasets preferably function to accumulate, store, maintain, and/or make available biographical, financial, and/or social data relating to the borrower.

As used herein, the term “NETWORK” shall generally refer to any suitable combination of the global Internet, a wide area network (WAN), a local area network (LAN), and/or a near field network, as well as any suitable networking software, firmware, hardware, routers, modems, cables, transceivers, antennas, and the like. Some or all of the components of the preferred system 10 can access the network through wired or wireless means, and using any suitable communication protocol/s, layers, addresses, types of media, application programming interface/s, and/or supporting communications hardware, firmware, and/or software.

As used herein and in the claims, the singular forms “a,” “an,” and “the” include plural references unless the context clearly dictates otherwise.

Unless defined otherwise, all technical and scientific terms used herein have the same meanings as commonly understood by one of ordinary skill in the art.

### DETAILED DESCRIPTION OF PREFERRED EMBODIMENTS

The following description of the preferred embodiments of the invention is not intended to limit the invention to these preferred embodiments, but rather to enable any person skilled in the art to make and use this invention. Although any methods, materials, and devices similar or equivalent to those described herein can be used in the practice or testing of embodiments, the preferred methods, materials, and devices are now described.

The present invention relates to improved methods and systems for scoring borrower credit, which includes individuals, and other types of entities including, but not limited to, corporations, companies, small businesses, and trusts, and any other recognized financial entity.

### System:

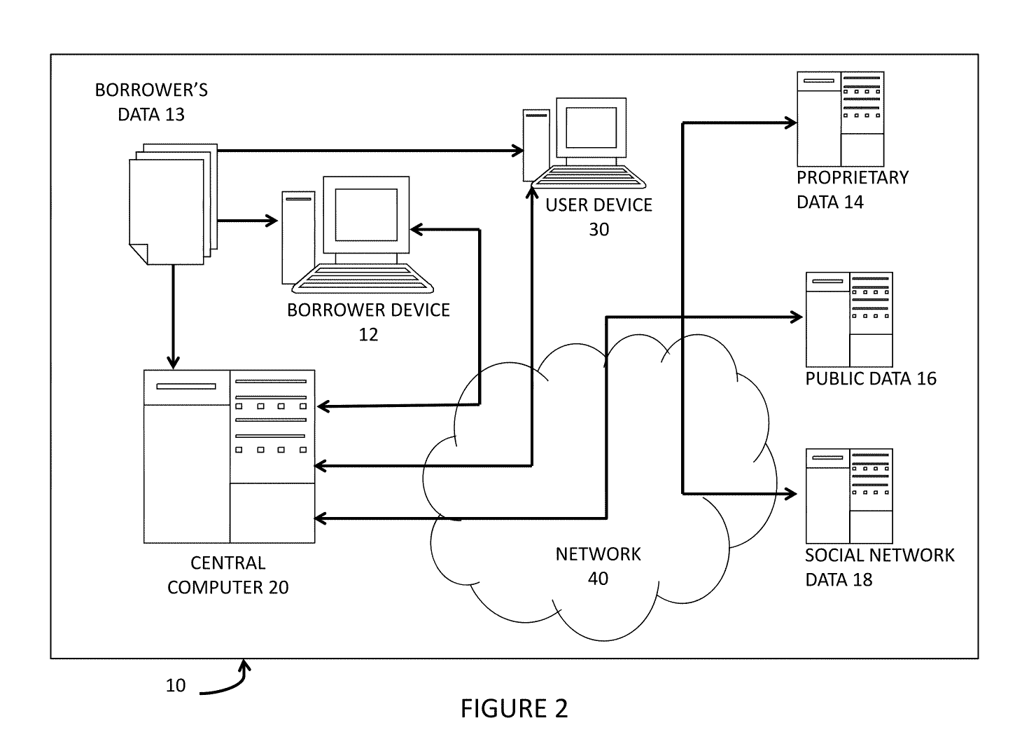

As shown in FIG. 2, a preferred operating environment for building and validating a credit scoring function in accordance with a preferred embodiment can generally include a BORROWER DEVICE 12, a USER DEVICE 30, a CENTRAL COMPUTER 20, a NETWORK 40, and one or more data sources, including for example BORROWER'S DATA 13, PROPRIETARY DATA 14, PUBLIC DATA 16, and SOCIAL NETWORK DATA 18. The preferred system 10 can include at least a CENTRAL COMPUTER 20 and/or a USER DEVICE 30, which (individually or collectively) function to provide a borrower with access to credit based on a novel and unique set of metrics derived from a plurality of novel and distinct sources. In particular, the preferred system 10 functions to determine the creditworthiness of borrowers, including the underbanked, by accessing, evaluating, measuring, quantifying, and utilizing a measure of risk based on the novel and unique methodology described below as well as in the system and method identified in the Merrill application, incorporated in its entirety by reference.

More specifically, this invention relates to the preferred methodology for building and validating a credit scoring that takes place within the CENTRAL COMPUTER 20 and/or a USER DEVICE 30, after all RAW DATASETS are temporarily gathered or otherwise downloaded from the BORROWER DEVICE 12, CENTRAL COMPUTER 20, USER DEVICE 30, and/or one or more data sources, including for example BORROWER'S DATA 13, PROPRIETARY DATA 14, PUBLIC DATA 16, and SOCIAL NETWORK DATA 18.

### Method Overview:

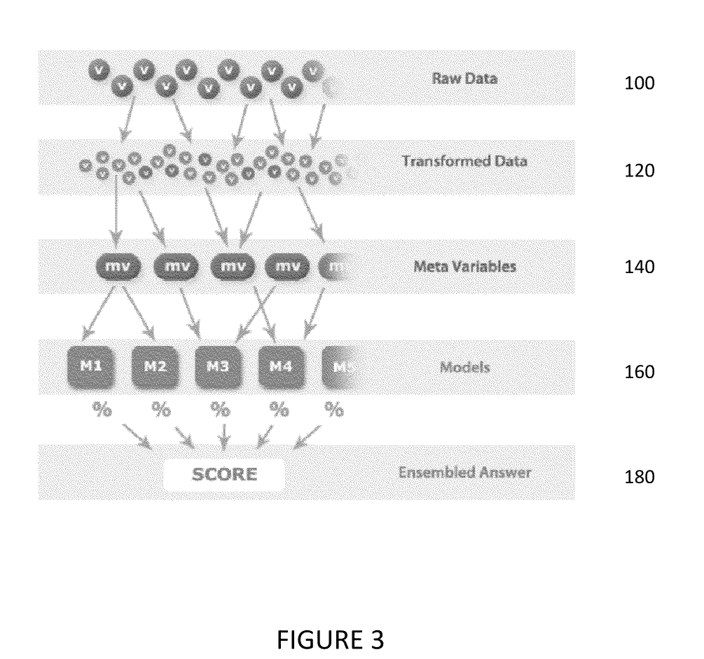

FIG. 3 provides a flowchart illustrating one preferred method by which the RAW DATASETS 100 (called “Raw Data” in the figure) are processed to build and validate a credit scoring function.

In the first step, the RAW DATASETS 100 are generated in response to receipt of a borrower's profile from one or more of the following BORROWER'S DATA 13, PROPRIETARY DATA 14, PUBLIC DATA 16, and SOCIAL NETWORK DATA 18. For example, the RAW DATASETS 100 may include classic financial data of the borrower's profile including items such as their FICO score, current salary, length of most recent employment, and the number of bankruptcies. Additionally, the RAW DATASETS 100 may include other unique aspects of the borrower, such as the number of internet domains owned, organizations the borrower has been or currently is involved with, how many lawsuits the borrower has been named in, the number of friends the borrower has, the psychological characteristics based on his or her interests, and other non-traditional aspects of the borrower's identity and history. Other examples include:

| | | |
|---|---|---|
| Past addresses within | Profession | Employment history |
| last 10 years | | and/or indicators of steady |
| | | employment. |
| Estimated annual | Other income | Payment frequency |
| income | | |
| Income for similar | Existing obligations | Interests |
| profession in same | (rent, child support, | |
| geographic area | etc). | |
| Duration of mobile | Rent or own house | Length of Home |
| phone number | | Ownership |
| ownership | | |
| Match of address | Late Payments | Income to expense ratio |
| entered by applicant to | (Credit card or | |
| those provided in | other) | |
| proprietary or public | | |
| data | | |
| Bankruptcies within | Number and | Sentiment and topic |
| the past 7 years? | stability of social | analysis of social network |
| | network friend list | postings |

By way of example and as used throughout this application, a small sampling of the RAW DATASETS 100 for fictitious borrower Ms. “A” (a creditworthy applicant) and fictitious borrower Mr. “B” (a rejected applicant) who reside and work near Represa, Calif., are:

| Variable | Source | Ms. “A” | Mr. “B” |
|---|---|---|---|
| Profession | Applicant | LPN | Prison Guard |
| Reported | Applicant | $32K/year | $65K/year |
| Income | | | |
| Similar | 3^{rd} Party | $35K-$40K | $35-45K/year |
| Income | | | |
| Other Income | Applicant | Owed $8K/year | $0 |
| | | child support. | |
| | | Never paid. | |
| Obligations | Applicant and | $800/mo rent | $1,200/mo rent |
| | 3^{rd} Party | | |
| Address | Applicant and | 2 addresses in 10 | 7 addresses in past 5 |
| Information | 3^{rd} Party | years | years |
| Late | Applicant and | 1—gas bill. | None reported |
| Payments | 3^{rd} Party | | |
| Social | Applicant and | One (1) registered | Four (4) registered |
| Security | 3^{rd} Party | SSN | SSN |
| Number | | | |
| Effort | Applicant | Total time to | Total time to |
| invested in | behavior | complete | complete |
| understanding | during | application: 45 | applications: 7 |
| lender's | application | minutes | minutes |
| products | process | Lender | Lender documents |
| | | documents | accessed (including |
| | | accessed | 3 loan application |
| | | (including 3 | forms): 3 |
| | | loan application | |
| | | forms): 15 | |

Second, the RAW DATASETS are transformed into a plurality of variables (transformed data 120) in their most useful form. For example, a “current income” variable could either be left in its native form or converted into a scale (0=no income; 1=$1-$5,000, 2=$5,001-$20,000, etc), or transformed to the percentile rank of the estimated income when compared to the DMA area where the applicant lives. Alternatively, the data for an address could be converted into latitude and longitude pairs (e.g. for 300 Prison Road, Represa, Calif. 95671 transformed to Lat.=38.6931632; Long.=−121.1616148), and thereafter use orthodromic distances to determine the likelihood that two listed addresses are in fact the same address. If the application is submitted by web site, then browser-related behavioral measurements, such as the number of pages viewed by the applicant and the amount of time the applicant spent on the actual application pages, can also be used as numerical signals related to creditworthiness.

Thereafter, a computer (such as the CENTRAL COMPUTER 20 in FIG. 2) shall independently process each of the plurality of variables using one or more algorithms (statistical, financial, machine learning, etc.) to generate a plurality of independent decision sets describing specific aspects of a borrower (Meta Variables 140). Assuming 40 variables in the RAW DATASETS, it is possible to generate (40²)=1600 potential comparisons of two discrete variables, (40³)=64,000 well-formed expressions using three variables, and (40⁴)=2,560,000 well-formed expressions using four variables, and so forth. Clearly, the number of transformed data 120 variables will grow exponentially in relation to the number of variables in the RAW DATASETS.

By way of example, the borrower's “current income” could be compared to the average income in Represa for others who work in the same profession. Similarly, the records of Applicant A's behavior during the application process show significant care and effort invested in the application, while the records of Applicant B's behavior during the application process show a careless and slapdash approach to credit. This could be transformed into an ordinal variable on a 0-2 scale, where 0 indicates little or no care during the application process and 2 indicates meticulous attention to detail during the application process. Applicant A would receive a high score such as 2, and Applicant B would receive a far lower one.

One purpose of meta-variables are measure creditworthiness. However, that is not their only function. For example, meta-variables are very useful at the intermediate stage of constructing a credit scoring function. There are three broad reasons that it is a good idea to build intermediate meta-variables when constructing a scoring function. First, the effort required to select the parameters that define a scoring function grows much faster than the number of parameters does. For a regression model, for instance, the amount of time to select n parameters grows as the cube of n. This means that the amount of computation required to directly estimate more than a few hundred parameters is impractical. By contrast, if those parameters are covered by a smaller collection of meta-variables, the amount of time required to select the parameters is much smaller. Second, the smaller number of parameters tends to make the behavior of the final scoring function more reliable: as a rule, optimization systems with more degrees of freedom (parameters) require more information about the world in the process of parametric selection than do models with fewer degrees of freedom. Using meta-variables reduces the number of parameters upon which the model depends. Third, and finally, meta-variables are reusable—if a metavariable provides useful information to one scoring function, it will often provide useful information to other scoring functions, even if the risks being evaluated by those others are only tangentially related to the one for which the metavariable was originally defined.

Meta-variables may also be used to perform a “veracity check” of the borrower. For example, Mr. B in the above example would not pass the “veracity check” since his reported income is 50% more than other individuals who work in the same profession in the same geographic area. Similarly, Ms. A would get a score of 2 on the “careful customer” test, which would usually be a signal indicating creditworthiness, in contrast to Mr. B, who would get a 0 on the same “careful customer” check, which would usually be a signal indicating less creditworthiness. Finally, Ms. A would typically get a high score on a “personal stability” scale, having been consistently reachable at a small number of addresses or phone numbers, where Mr. B would typically get a lower score on the same scale.

Moreover, statistical analysis of meta-variables are instructive as to which “signals” are to be measured, and what weight is to be assigned to each. For example, consistency of residence may be a “positive” signal, while plurality of addresses might generate no signal. The preferred embodiments of the present invention is likewise instructive as to that determination. Indeed, constructing meta-variables may not be a fully automated process, but rather a heuristic one, calling for expert skill. In general, however, the process of constructing a metavariable proceeds as outlined next. (This document restricts its examples to the construction of meta-variables related to loan risk assessment, but the methodology is more generally applicable.) First, a data analyst identifies a class of applications that have some common property—among loan applications, this might be a set of applications which have higher or lower risk than average. The putative “personal stability” and “careful customer” examples above could easily be recognized—an analyst might notice that people who move very rarely are better credit risks and that people who move frequently are poorer credit risks. This class can be identified by a wide collection of techniques, ranging from manual examination of applications and outcomes to “find features which split risk” to complex statistical techniques in which clustering analysis is used on applications which were predicted incorrectly by an established scoring procedure to find “predictive subsets”.

The purpose of a metavariable is to create a real-value score which separates members of these classes from non-members. This is typically performed by using a basic machine learning process to assemble one or more relatively simple expressions which “separate the classes”. Such an expression might be the output of a linear regression across a small constellation of measured signals, possibly including already-known meta-variables, or a small classification or regression tree applied to a similar constellation of signals. The critical features that make one of these meta-variables something other than a true scoring function are (1) prizing simplicity and stability over accuracy—a metavariable doesn't need to be always right by itself, but must instead be a reliable signal which can be depended upon even if the environment changes; and (2) aiming to provide correlative signals related to a portion of the scoring problem instead of trying to directly provide a final value.

A single class of documents or applications can easily lead to several meta-variables, each of which measures a “different” aspect of the class. Similarly, a single document can serve as an exemplar in multiple classes; in fact, by so serving, such a document provides direction about how meta-variables should be assembled into a final scoring function.

In the preferred method, the fourth step includes feeding the Meta-Variables into statistical, financial, and other algorithms each with a different predictive “skill” (Models 160). By way of example, a predicted payback model may easily add simple meta-variables such as the ratio between the requested “loan value” to “current income,” or it may take the form of complex algorithms such as borrower's social or financial volatility indices. For instance, one can use traditional machine learning techniques, such as regression models, classification trees, neural networks, or support vector machines to build scoring systems on the basis of the past performance data, producing a variety of complex algorithms for quantifying aggregate risk.

Finally, each of the Models may then “vote” their individual importance, which then may be assembled into a final score (Score 180). There are many ways to assemble scores using machine learning or statistical algorithms, but, for clarity, we provide a simple example. In this trivial example, the score provided by each model could be transformed onto a percentile scale, and the median value of all the assigned scores could be computed. For instance, we could use a group of models, one (“Model I”) based on a random forest of classification trees, another, (“Model II”), based on a logistic regression, and a third (“Model III”) based on a neural network trained with back-propagation, and aggregate their results by averaging. This is complicated by the fact that the different models naturally return values on very different ranges, and so it is preferable to pre-normalize their scores before averaging them.

For clarity, assume that Model I returns 0.76 for Ms. A, Model II returns 0.023, and Model III returns 0.95. Assume further that these normalize to 83/100, 95/100, and 80/100, respectively. Then the aggregate score for Ms. A would be the average of these values, or 86/100. For contrast, assume that Model I returns 0.50 for Mr. B, Model II returns 0.006, and Model III returns 0.80, and that these normalize to 55/100, 48/100, and 62/100, respectively. In that case, the final score for Mr. B would be 55/100, the average of the three values. If one decided whether to grant a loan to an applicant only if their aggregate score was at least 80, then Ms. A would be offered a loans, and Mr. B would be denied a loan.

As showing in the overview in FIG. 3, in the preferred method, data contained in the RAW DATASETS 100 is gathered, cleansed, transformed in their most useful form, combined into meta-variables defining specific aspects of the buyer, fed in different models, and finally assembled into a score for a final creditworthiness decision. The following topics will be addressed in greater detail below: how the preferred method examines the broad categories of transformations which are available, how to select those which will be useful, how to enumerate computational strategies for handing the resulting flood of information, and how to point out the targets which are feasibly useful due to the greater amount of computation that may be performed. The training and validation process for risk measuring functions based on these inputs and targets follow:

### Detailed Method:

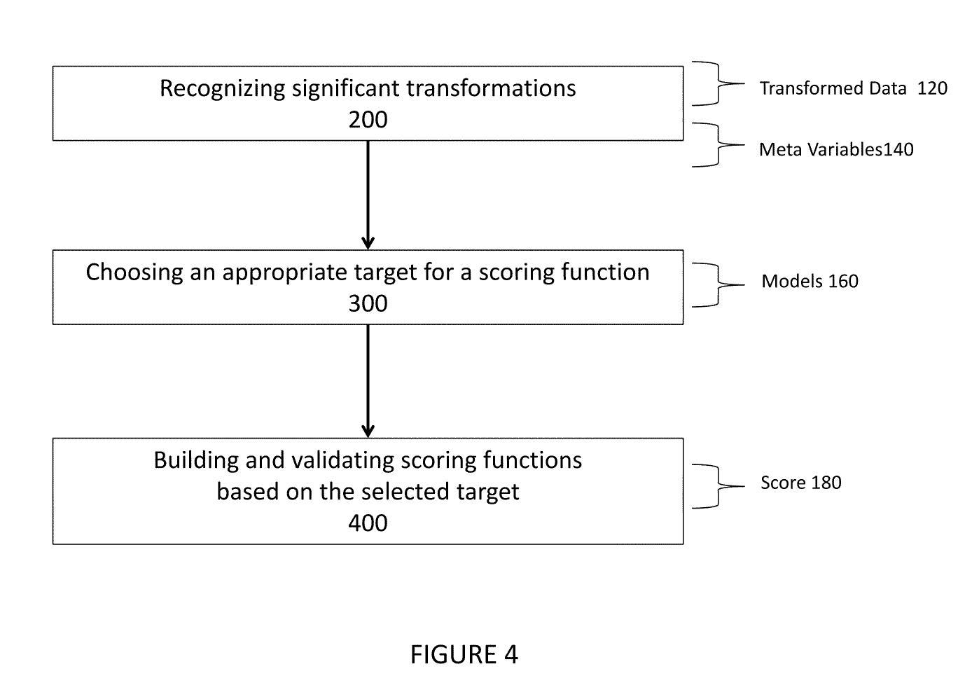

As shown in FIG. 4, the preferred method for building and validating a credit scoring function involves the following steps: (a) recognizing significant transformations 200; (b) choosing an appropriate target for a scoring function 300; and (c) building and validating scoring functions based on the selected target 400.

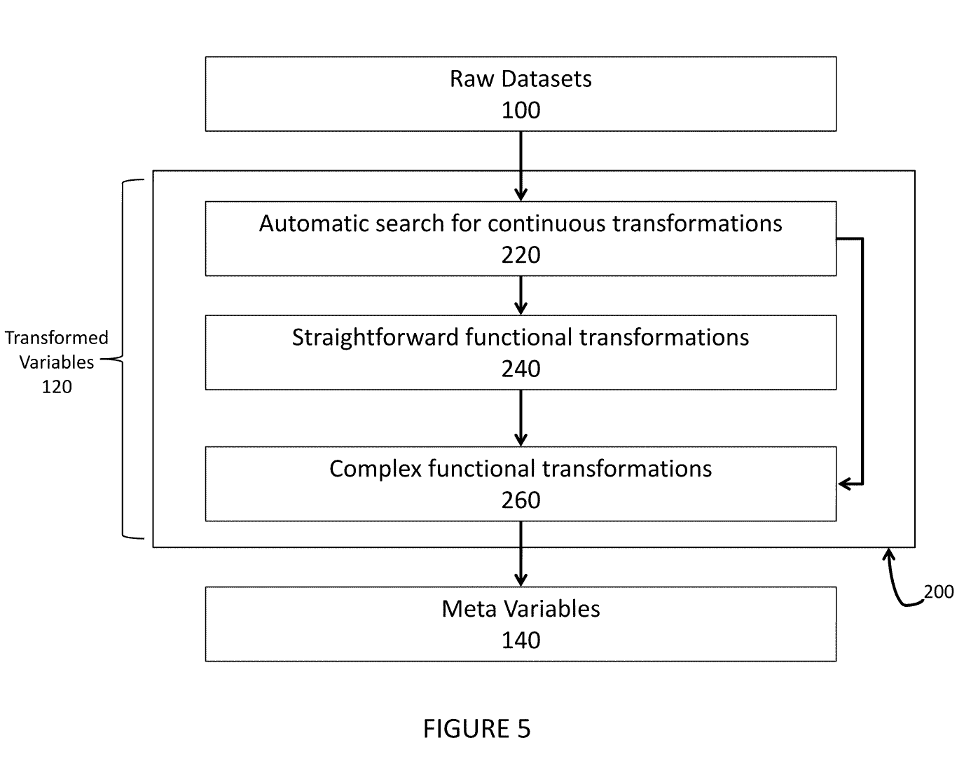

As shown in FIG. 5, the preferred method for recognizing significant transformations 200, commences with feeding the RAW DATASETS 100 into the following transformation processes: (a) an automatic search for continuous transformations 220; (b) a straightforward functional transformations 240; and (c) complex functional transformations 260, which likely results in the creation of new transformed variables 120 and/or new meta variables 140.

The automatic search for continuous transformations 220 include the application of standard variable interpretation methods, such as (a) factorization for string variables with relatively few distinct values, followed by translation of those terms into indicator categories when fill in is necessary (b) conversion to doubles for variables which may represent Boolean terms; (c) translation of dates into offsets relative to one or more base time stamps; (d) translation of addresses or other geo-location data in a standard form, such as latitude-longitude representation. The application of automatic search for continuous transformations 220 usually result in the creation of transformed variables 120 and/or meta variables 140. However, if the automatic search for continuous transformations 220 determines that one or more of the variables in the RAW DATASETS 100 does not require manipulation, the data may not be transformed, and instead be passed through in its native format. For Example, One can view the standard quartet of payment patterns (weekly, bi-weekly, semi-monthly, and monthly) as a factor variable with four levels, or as a set of four binary variables of which one if one and the other three are zero. Either of these interpretations is a standard, mechanically implementable, example of this kind of transformation.

For instance, a variable that can assume the values “Paid weekly”, “paid biweekly”, “paid semimonthly” or “paid monthly” could be transformed into four integral values from 1 to 4, or into four sets of quadruples, (1, 0, 0, 0), (0, 1, 0, 0), (0, 0, 1, 0), and (0, 0, 0, 1), respectively, depending on how the values would be used later on. The values “True” and “False” can be transformed into 0.0 and 1.0. Dates can be transformed to date offsets (e.g. the date Oct. 18, 1960 could be represented as “Day 22205 since Jan. 1, 1900.”) Finally, the address 300 Prison Road, Represa, Calif. 95671 can be converted to geographical coordinates 38.6931°N 121.1617°W, which can be determined to be 23530.62 miles from 38.8977°N, 77.0366°W (the geographical coordinates of 1600 Pennsylvania Avenue, Washington, D.C.) Given the distance, a computer could conclude, automatically, that someone residing at the first address was very unlikely to work at the second (A human who saw these two addresses would know that someone who resides at 300 Prison Road is an inmate at California's oldest maximum-security prison, and would be unlikely to work at the White House. Computers don't have the cultural knowledge necessary to draw that conclusion.)

The resulting transformed variables 120 and/or meta variables 140 created by the automatic search for continuous transformations 220, are then fed into straightforward functional transformations 240, examples of which include (a) translation of singletons or small groups into outcome-related metrics, such as the inferred probability of success or the expected value of some outcome variable (e.g. expected payoff of a single loan given a particular value of the variable); (b) simple functional transformations of a variable (e.g. if a single field contains the count of events of a particular type, then that field will often follow a Poisson distribution. If so, then the square root of that field will closely follow a Gaussian distribution with a known mean and variance.). Moreover, the straightforward functional transformations 240 can employ other statistical algorithms as predictors, including for example a Mahalanobis distance measure (such as a traditional Euclidean distance measure, a high-order distance measure, a Hamming distance measure), a non-normally distributed distance measure, and/or a Cosine transform. The application of straightforward functional transformations 240 usually result in the creation of additional transformed variables 120 and/or meta variables 140. However, if the straightforward functional transformations 240 determine that one or more of the variables in the RAW DATASETS 100 does not require manipulation, the data may not be transformed, and instead be passed through in its native format.

For instance, consider the distance example given before. One could imagine transforming that distance into a measure of the probability that someone with a given distance between home and work would pay off a loan. Presumably, that probability would be lower for someone who lived and worked at the same location, would rise for a while, and would then tend to fall. In the intermediary step of performing a straightforward functional transformation 240, the preferred embodiment of the present invention would look at all the address data for the borrower and determine whether the addresses are indeed likely to live and work within a commutable distance, and verify the data set of addresses to work with.

Finally, the resulting transformed variables 120 and/or meta-variables 140 created by either the automatic search for continuous transformations 220 or the straightforward functional transformations 240, are then fed into a complex functional transformations 260, examples of which include (a) transformations of singletons or small groups using careful selected and/or constructed functions; (b) distances between pairs of items (i.e. the absolute value of a difference for numerical fields, the Euclidean or taxi-cab distance for points in space, or even a string edit distance for textual fields (the last of which is of great value when dealing with user input, in order to differentiate between errors and fraud)); (c) ratios of items (e.g. the ratio of debt service load to household disposable income); (d) other geometric transformations (e.g. the area of a k-simplex of suitable clusters of measures, a generalization of distance, and/or other complex measures of stability as a function of address can be computed); and (e) custom-constructed functional transformations of data. The application of complex functional transformations 260 usually result in the creation of additional transformed variables 120 and/or meta variables 140. However, if the complex functional transformations 260 determine that one or more of the variables in the RAW DATASETS 100 does not require manipulation, the data may not be transformed, and instead be passed through in its native format.

Again, referring to the example two paragraphs above, wherein meta-variables could be used transforming that distance into a measure of the probability that someone with a given distance between home and work would pay off a loan, the final intermediary step are complex functional transformations 260 to determine the employment stability of the borrower. To the extent that the number of places someone has lived in a given period tends to obey a Poisson distribution with mean proportional to the number of jobs that person has held, transforming the pair of items consisting of the number of recent jobs and the number of recent addresses by taking the square root of both turns them into a set of pairs which are related by a linear relationship plus a univariate Normal distribution with variance ¼. This, in turn, allows us to easily distinguish people who've “just had a lot of jobs” from people who've had “more addresses than one would expect given the number of jobs they've held.”

Creating custom-constructed functional transformations of data is closely related to large data analysis. Depending on the size of the RAW DATASETS 100, the number of well-formed expressions (i.e. transformed variables 120 and/or meta variables 140) defining a function of a single variable may be extremely large, with the number of well-formed expressions defining a function of several variables grows exponentially. For example, if there are 40 variables in the RAW DATASETS 100, there are (40²)=1,600 potential differences, (40³)=64,000 well-formed expressions using three variables in a “ratio of a single variable to the difference of two others”, and (40⁴)=2,560,000 well formed expressions of the form “ratio of the difference between two variable to the difference between two, potentially different, variables.” With a larger set of variables, the growth is much faster. Searching such a space is, itself, a difficult optimization problem, both because of the size of the space and, more importantly, because most functions are not relevant to determining creditworthiness.

Notwithstanding, there are a number of preferred methods for automatically searching such a space, including without limitation: brute force; simple hill-climbing (in which a computer starts with a random example function and incrementally modifies it to build a “better function”); simulated annealing, a modification of hill-climbing that is guaranteed to always find the best possible tuple, given time; general methods recognized in set theory; or other discrete search methods.

Still, these methods may not predefine what a “better transformation” is, or how to measure how much better one transformation is than another. Thus, implementing such a search, generally calls for both the definition of “better” for the purposes of risk evaluation and the selection of a computational architecture within which such a search can be performed. This problem is more appropriately referred to as “choosing the appropriate target for a scoring function.”

Referring back to FIG. 4, once the final set of meta variables 140 are created as described above, they are then run through a process of choosing an appropriate target for a scoring function 300 by which risk is measured. The preferred method of selection may be accomplished by a machine learning algorithm to select one or more meta variables 140 which are deemed “better” or the “best” predictors of risk through logistic regression, polynomial regression, or a variety of other general and robust optimization schemes. Traditionally, the models have targeted “default rate”, thus simply predicting the probability of future loan default based on the fraction of loans which defaulted over time. However, given the robust computational power of most modern computers, new model predictors may be preferable in evaluating borrower risk. For example, one could attempt to predict the interval between the time of a missed payment and the time that a loan is “cured” by the borrower making the delayed payment. However, the results produced by this model are not bounded, and can be quite ill-behaved. But, by including smoothing and regularization terms in the objective function being optimized, scores may be fitted tightly, resulting in a reliable risk function that generalizes well to new loans.

Once a target model (or models) to predict risk has been selected (e.g., the models 160 as shown in FIG. 3), the final step is determining what part of the scoring function should be optimized and how (the method of “building and validating a scoring function based on the selected target” 400 as shown in FIG. 4).

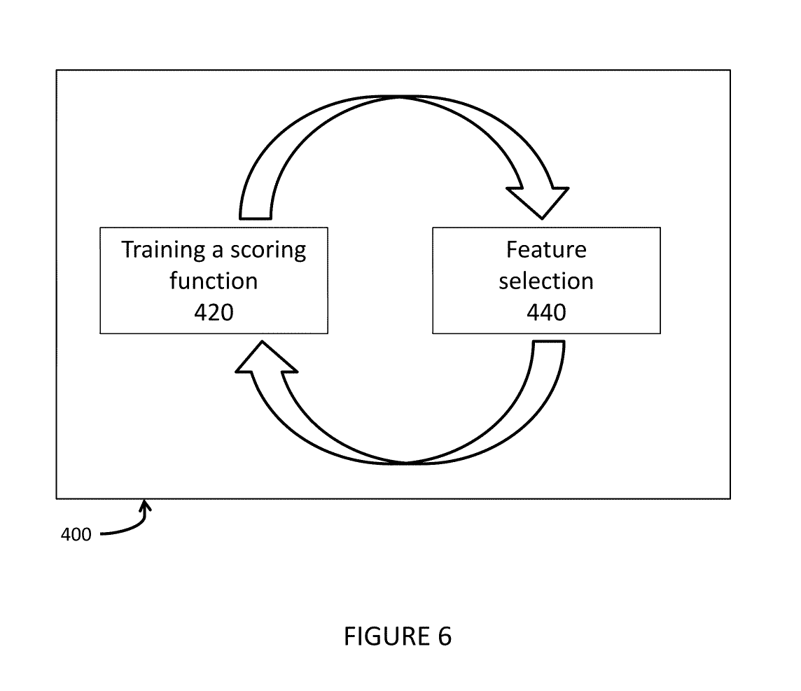

As further shown in FIG. 6, the preferred method for building and validating a scoring function 400, includes training a scoring function 420 and feature selection 440.

Given a set of thousands of past loans, their outcomes, and a set of features as described about, one could, in principle, use something as simple as linear regression to use any set of numeric features arising from the previous transformations to predict outcomes. One could then analyze the resulting model using standard statistical procedures to find a submodel that is not only accurate, but also very stable. This model could then be used to predict performance on new loans, allowing one to use this function to decide whether to grant loans to them.

The preferred method of training a scoring function 420 is by using a statistical or machine learning algorithm. These algorithms often encounter problems with generalization: the more closely a scoring function can fit the data used to “train” it, the less well it will do on data upon which it wasn't trained. While there exist a number of methods of solving the “generalization” problem, three are preferable: (a) penalty terms: by penalizing the scoring function for being too unstable, the result forces the selected to be more stable off the trained dataset; (b) aggregation: by building a scoring function from the average of several simpler scoring functions, the results is a better tradeoff between flexibility and predictability; and (c) test set reservation: by reserving a portion of the training data and using it only to evaluate the scoring function, one can estimate the performance on untrained data by measuring performance on that reserved set, which is, by virtue of having been withheld, untrained data. An alternative method for resolving the “generalization” problem may be yielded by using more subtle techniques, such as cross-validation, boosted aggregation (bagging), and similar methods, to make better use of the available training data.

For instance, given a set of thousands of past loans, one could train up a model on all of these, and try to use that model as a scoring function in the future. Alternatively, one can split this set up into several pieces and train only on some of them. One can then evaluate the performance of the model on some or all of the other portions of the training set, and by this means estimate what performance will be on novel loan applications. By selectively retaining or rejecting signals, one can adjust the behavior of the scoring function to maximize this generalization performance.

As shown in FIG. 6, the second challenge that arises is determining which variables in the RAW DATASETS 100, transformed data 120, and meta variables 140 should be selected for the training a scoring function 420 (the so called “feature selection” 440 problem). Amongst a number of methods, two non-mutually exclusive methods are preferable: (a) per feature information measurement; and (b) two level optimization.

Per feature information measurement may include one or more fast but crude training methods (such as Breitman's “Random Forest”) applied to a large set of variables. Thereafter, a preferred method may include performing the equivalent of an ANOVA to the resulting scoring function to extract those variables which provide the most information, and thereafter restrict the scope of the final scoring function to only use those “most important” variables.

Two level optimization may include the discrete search methods list above or Holland's Genetic Algorithms. Such functions serve to combine the training and feature selection processes and perform them simultaneously. For example, a Genetic Algorithms implementation would use chromosomes which represented feature sets and would evolve those feature sets to get the best possible generalization on a reserved testing set. As such, the result may permit the use of arbitrarily complicated features while controlling for variability.

All of the above described methods for the preferred method for building and validating a scoring function 400 may utilize significant processing power. In order to reduce processing time, these methods may be decomposed into layers of “embarrassingly parallel tasks,” which have no interdependence among or between themselves. For example, the scoring of each individual model in the population of a Genetic Algorithms feature selection process is independent of all the others, and thus may run more efficiently on separate machines. Likewise, the gathering of selection results may also be assembled on a separate computer to build the next generation of models.

Any of the above-described processes and methods may be implemented by any now or hereafter known computing device. For example, the methods may be implemented in such a device via computer-readable instructions embodied in a computer-readable medium such as a computer memory, computer storage device or carrier signal.

The preceding described embodiments of the invention are provided as illustrations and descriptions. They are not intended to limit the invention to precise form described. In particular, it is contemplated that functional implementation of invention described herein may be implemented equivalently in hardware, software, firmware, and/or other available functional components or building blocks, and that networks may be wired, wireless, or a combination of wired and wireless. Other variations and embodiments are possible in light of above teachings, and it is thus intended that the scope of invention not be limited by this Detailed Description, but rather by Claims following.

What is claimed is:

1. A central computer server communicatively coupled to a public network, the central computer server having a computer-usable medium with a sequence of instructions which, when executed by a processor, causes said processor to execute an electronic process that assesses a borrower's credit risk, said process comprising:
searching and collecting a dataset for the borrower from at least one of the following sources: the borrower, private data, public data, or social networking data sources, via the public network,
transforming the dataset into a plurality of variables related to the borrower's credit risk;
independently processing each of the plurality of variables using a statistical algorithm or a machine learning algorithm to generate a plurality of meta-variables describing specific aspects of the borrower; and
calculating an objective credit risk score based on said plurality of variables and meta-variables for the borrower.

2. The computer system of claim 1, wherein the step of searching and collecting a dataset for the borrower from the borrower is accomplished through either a live interview via the public network or by having said user fill-out an online questionnaire.

3. The computer system of claim 1, wherein the step of searching and collecting a dataset for the borrower from private data comprises:
providing a subset of borrower specific data to a private data vendor; and
electronically receiving and collecting all or a portion of the relevant borrower data that is owned by said vendor into a database of variables

4. The computer system of claim 1, wherein the step of searching and collecting a dataset for the borrower from public data comprises
performing search strings, automated crawls, or scrapes using a program or protocol; and
collecting all returned results into a database of variables.

5. The computer system of claim 1, wherein the step of searching and collecting a dataset for the borrower from social network data comprises:
searching said social networks for data posted by the borrower;
searching said social networks for data collected related to the borrower, as compiled by the social media service;
searching said social networks for data social graph information for any or all members of the borrower's social network, thereby encompassing one or more degrees of separation between the borrower profile and the data extracted from the social network data; and
collecting all returned results into a database of variables.

6. The computer system of claim 1, wherein the step of transforming the dataset into a plurality of variables is accomplished by transforming the variables collected from the searching and collecting step into standardized date formats, standardized time formats, scales, percentile ranks, latitude and longitude pairs.

7. The computer system of claim 1, wherein the step of independently processing each of the plurality of variables using a statistical algorithm or a machine learning algorithm to generate a plurality of meta-variables describing specific aspects of the borrower comprises:
comparing the borrower's data for each variable to data in other variables in the borrower's profile;
comparing the borrower's data to the averages expected for other similarly situated persons with similar characteristics as the borrower; and
comparing the borrower's behavior during his or her preparation of the loan application.

8. The computer system of claim 7, wherein the step of generating a plurality of variables further comprises:
analyzing data to identify a class of applications that have at least one common property by using risk-splitting techniques or complex statistical techniques to find predictive subsets;
using linear regression or regression trees to separate members of the class from non-members that do not reliably produce correlative signals; and
selecting said meta-variables which measure different aspects of the class only.

9. The computer system of claim 1, wherein the step of calculating an objective credit risk score based on said plurality of variables and meta variables for the borrower comprises:
feeding the meta-variables into statistical or financial models each with a different predictive outcome; and
ensembling the normalized scores from each said model, using simple arithmetic, machine learning or statistical algorithms, to compile a composite score.
